(19) United States
(12) Patent Application Publication
(10) Pub. No.: US 2017/0246759 A1
(43) Pub. Date: Aug. 31, 2017

(54) METHODS AND SYSTEMS FOR LIMITING CARBON MONOXIDE OFF-GASSING

(71) Applicants: Philip K. Hopke, Potsdam, NY (US); Mohammed Arifur Rahman, Potsdam, NY (US)

(72) Inventors: Philip K. Hopke, Potsdam, NY (US); Mohammed Arifur Rahman, Potsdam, NY (US)

(73) Assignee: Clarkson University, Potsdam, NY (US)

(21) Appl. No.: 15/424,304

(22) Filed: Feb. 3, 2017

Related U.S. Application Data
(60) Provisional application No. 62/299,835, filed on Feb. 25, 2016.

(51) Int. Cl. B27K 5/00; F26B 1/00

(52) U.S. Cl. CPC B27K 5/001; F26B 1/00; B27K 2200/10

(57) ABSTRACT

Methods and systems for treating wood byproducts, the method comprising the steps of: (i) providing a first quantity of wood byproducts in a first location; and (ii) exposing the first quantity of wood byproducts to ozone at a first concentration for a first time period, wherein the first concentration is configured to decrease the release of carbon monoxide from the first quantity of wood byproducts.

### CROSS-REFERENCE TO RELATED APPLICATION

This application claims priority to U.S. Provisional Patent Application Ser. No. 62/299,835, filed on Feb. 25, 2016 and entitled “Mechanistic Pathway of Carbon Monoxide Off-Gassing,” the entire disclosure of which is incorporated herein by reference.

### FIELD OF THE INVENTION

The present disclosure is directed generally to methods and systems for managing carbon monoxide release, and more particularly to suppression of carbon monoxide release using ozone.

### BACKGROUND

Carbon monoxide (CO) poisoning is a serious health risk. According to the Centers for Disease Control and Prevention, more than 400 Americans die from unintentional CO poisoning, more than 20,000 visit the emergency room, and more than 4,000 are hospitalized.

There are many sources of carbon monoxide, although the most common source is combustion of fuel, such as in motor vehicles, small engines, stoves, lanterns, grills, fireplaces, gas ranges, or furnaces. During combustion, CO is produced and/or released and can build up in an enclosed space to poison the people and animals who breathe it.

One common source of CO is from stored wood products such as wood pellets and wood chips. Several people have died or been injured as a result of unloading wood pellets in homes or unventilated storage compartments. Several studies have been conducted demonstrating that the levels of CO off-gassing from stored wood pellets constituted both occupational and domestic health hazards. The findings support the assertion that storage areas for pellets in commercial buildings must be considered confined spaces and require appropriate entry procedures.

Due to the dangers associated with CO off-gassing from stored wood pellets, several entities such as the New York State Energy Research and Development Authority (NYSERDA) preclude support of in-building pellet bins. This preclusion represents a significant barrier to increased use of pellet-based appliances.

Accordingly, there is a need in the art for methods and systems for limiting or eliminating CO off-gassing from stored wood pellets, thereby mitigating the hazards presented by off-gassed CO.

### SUMMARY

The present disclosure is directed to methods and systems for treating wood byproducts in order to decrease or eliminate CO off-gassing from the wood. Extensive experimentation demonstrated that autoxidation was responsible for a significant percentage of the CO off-gassing from stored wood. A novel approach to prevent CO off-gassing was developed using ozone. This treatment of the wood byproducts results in low or no CO emission.

According to an aspect is a method for treating wood byproducts. The method includes the steps of: (i) providing a first quantity of wood byproducts in a first location; and (ii) exposing the first quantity of wood byproducts to ozone at a first concentration for a first time period, wherein the first concentration is configured to decrease the release of carbon monoxide from the first quantity of wood byproducts.

According to an embodiment, the first concentration of ozone for the first time period is at least approximately 60,000 ppm-minutes.

According to an embodiment, the first concentration is configured to decrease the release of carbon monoxide from the first quantity of wood byproducts by at least approximately 90%.

According to an embodiment, the wood byproducts are sawdust, wood chips, or wood pellets.

According to an embodiment, the first location is a wood pellet mill.

According to an aspect is a method for treating wood byproducts. The method includes the steps of: (i) providing a first quantity of wood byproducts in a first location; and (ii) exposing the first quantity of wood byproducts to ozone at a first concentration for a first time period, wherein the first concentration of ozone for the first time period is at least approximately 60,000 ppm-minutes, and further wherein the first concentration is configured to decrease the release of carbon monoxide from the first quantity of wood byproducts by at least approximately 90%.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a flowchart of a method for treating wood byproducts, in accordance with an embodiment.

FIG. 2 is a thermogram of fresh hardwood pellets and aged hardwood pellets (aged 60 days at 6 to 8° C.), in accordance with an embodiment.

FIG. 3 is a thermogram of hemicellulose from a dietary supplement), in accordance with an embodiment.

FIG. 4 is graph of fatty acid concentrations measured in samples of hardwood, softwood, and blended pellets, in accordance with an embodiment.

FIG. 5 is a chromatogram of VOCs sampled and analyzed by GC/MS, in accordance with an embodiment.

FIG. 6 is a graph of CO concentrations over time in 1L containers with cellulose, hemicellulose (in air and in nitrogen), and biomass, in accordance with an embodiment.

FIG. 7 is a graph of CO emissions from blended wood pellets with and without the addition of 1-butanol, in accordance with an embodiment.

FIG. 8 is a graph of CO emissions from ozonized and unreacted blended wood pellets, in accordance with an embodiment.

FIG. 9 is a graph of CO emissions from ozonized and unreacted blended wood fiber, in accordance with an embodiment.

FIG. 10 is a graph of fractional reduction in CO as a function of the ozone concentration-time product (exposure) for two different auger speeds, in accordance with an embodiment.

### DETAILED DESCRIPTION OF EMBODIMENTS

The present disclosure describes methods and systems for treating wood byproducts. A quantity of wood byproducts is stored in a first space such as a storage facility or as part of a manufacturing facility such as a materials auger that moves the wood byproducts or other similar space. The quantity of wood byproducts can then be exposed to ozone at a first concentration for a predetermined time period. The first concentration is configured to substantially decrease the release of carbon monoxide from the first quantity of wood byproducts.

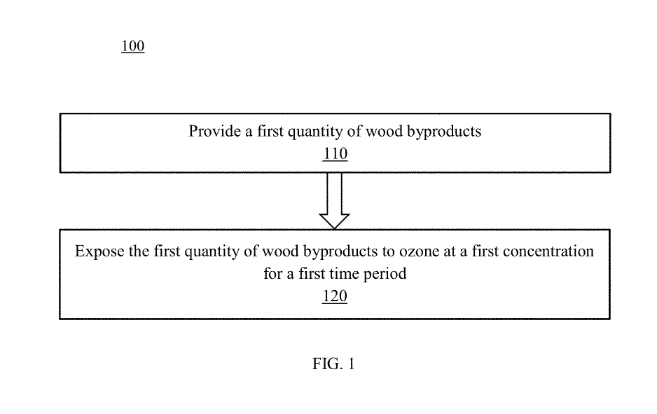

Referring to FIG. 1, in one embodiment, is a flowchart of a method 100 for suppression of carbon monoxide (CO) release. As described herein, CO is released from wood products such as wood pellets and wood chips, sometimes at levels that are dangerous or lethal to humans or animals, particularly in an enclosed space without sufficient ventilation. Accordingly, there is a need for methods and systems that limit or eliminate CO off-gassing from wood pellets, thereby mitigating the hazards presented by the off-gassed CO.

At step 110 of the method, a first quantity of wood or wood byproducts is provided in a first location. The first quantity of wood or wood byproducts may be any quantity of raw wood material, wood chips, wood pellets, sawdust, or any wood byproduct that produces CO. The location may be a location where CO off-gassing can occur, such as a manufacturing or shipping facility.

At step 120 of the method, the first quantity of wood byproducts is exposed to ozone at a first concentration, wherein the first concentration is configured to decrease the release of CO from the first quantity of wood byproducts. According to an embodiment, wood is exposed to the ozone while it is being processed in a wood pellet mill. Thus, at one or more stages of milling, fiber transport, and/or pelletization, the wood byproducts can be exposed to the ozone. For example, as a materials auger transfers the reduced size material from the hammer mill to the pellet press, the wood fiber can be exposed to the ozone treatment. Many other examples are possible.

The concentration of ozone is any concentration configured to or sufficient to substantially decrease or prevent the release of CO from the first quantity of wood byproducts. Notably, the concentration of ozone can depend on the amount and nature of wood byproducts within the space. According to one embodiment, for example, the concentration of ozone may be 6000 ppm, or much greater than 6000 ppm. Many other concentrations are possible.

According to an embodiment, the product of time and ozone concentration is a key variable in preventing or decreasing CO off-gassing from wood byproducts. For example, the wood byproducts may be exposed for at least 56,000 to 60,000 ppm-minutes of exposure, although other values and ranges are possible.

Thermogravimetric Experiments

Wood is essentially composed of cellulose, hemicelluloses, lignin, and extractives. It has previously been determined that storage of the pellets for extended periods of time results in a substantial reduction in off-gassed CO. For example, storage at 6 to 8° C. for 30 days reduced the maximum observed CO by a factor of 2.

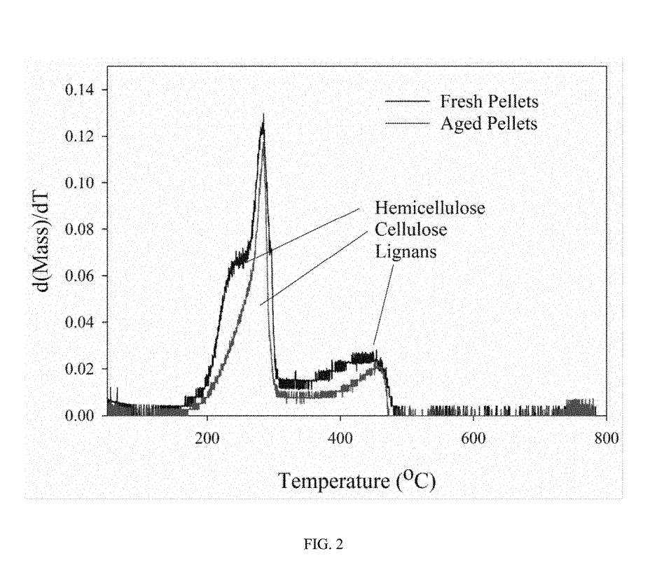

To identify the components that were reduced in concentration over that time, thermographic analysis (TGA) was used. In this analysis, ground wood samples were placed in the instrument where their weight was continuously measured as the temperature was increased so that the rate of loss of mass could be observed at a function of temperature. Referring to FIG. 2 is a comparison of thermograms obtained with fresh versus aged hardwood pellets. The peak for hemicellulose decreased substantially in the aged pellets. To further characterize the wood components, a sample of lab grade cellulose was obtained and the thermogram of this material compared well with the peak remaining in the wood sample following aging process and again suggests that during the storage period much of the hemicellulose decomposed. Thus, it is hypothesized that the bulk of the CO is produced by the oxidation of hemicellulose.

Evolved Gas Analysis Experiments

Hemicellulose consists of heteropolymers of pentose (xylose and arabinose) and hexose (glucose, galactose, and mannose) and sugar acids (acetic). Hardwood hemicelluloses are xylans whereas softwood consists of glucomannans. Cellulose consists of homopolysaccharides composed of -D-glucopyranose units linked together by 1-4 glycoside bonds. The oxidation of any of these components might contribute to CO production. However, none of these compounds will be easily oxidized at room temperature and pressures. Thus, the decomposition products in the gas evolved during the TGA analyses were collected and analyzed.

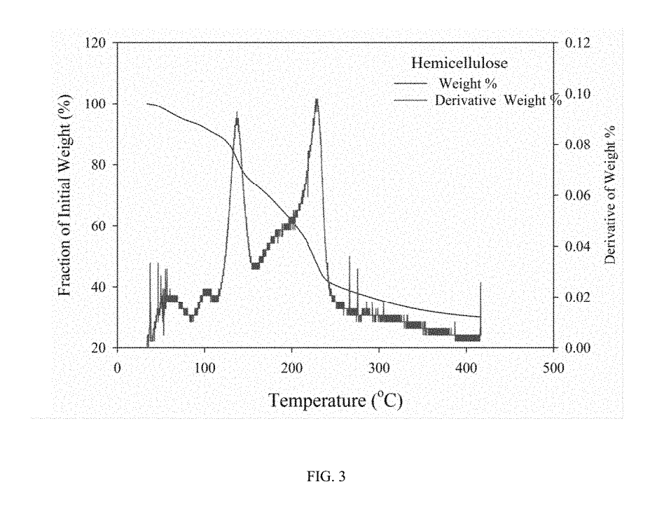

A sample of hemicellulose sold as a dietary supplement was purchased and a thermogram of this material is shown in FIG. 3. It was expected that identification of the major components would shed light on the oxidation/breakdown processes. This Tedlar hag sampling permitted multiple direct injections of the evolved gas sample into the GC-MS. Compounds were identified by comparing their mass spectra with the NIST MS library. A number of peaks with reasonable intensities were observed. However, it is not clear how well this material reflects the nature of the hemicellulose in a wood sample given that it produces a very different thermogram from what was observed with the hardwood sample, as seen by comparing FIGS. 1 and S4.

Previous studies of TGA-evolved gas of the pyrolysis of cellulose, hemicellulose, and lignin used FTIR spectroscopy and concluded that CO was mainly released by the cracking of carbonyl and carboxyl arising from hemicellulose pyrolysis and the contribution of cellulose pyrolysis to CO was minor.

GC/MS screening of the TGA-evolved gas from wood showed mostly aldehydes and carboxylic acids. The TGA-evolved gas of hemicellulose shows carboxylic acids peaks that also support the above findings. A chromatogram of the cellulose TGA-evolved gas shows few acids compared to hemicellulose. In addition, the TGA-evolved gas from hemicellulose is unlikely to be more aromatic in nature than the products from cellulose. However, these observed emissions would not result in the more than 1000 ppm of CO produced by wood pellets at room temperature that were measured in previous studies.

Fatty Acids Experiments

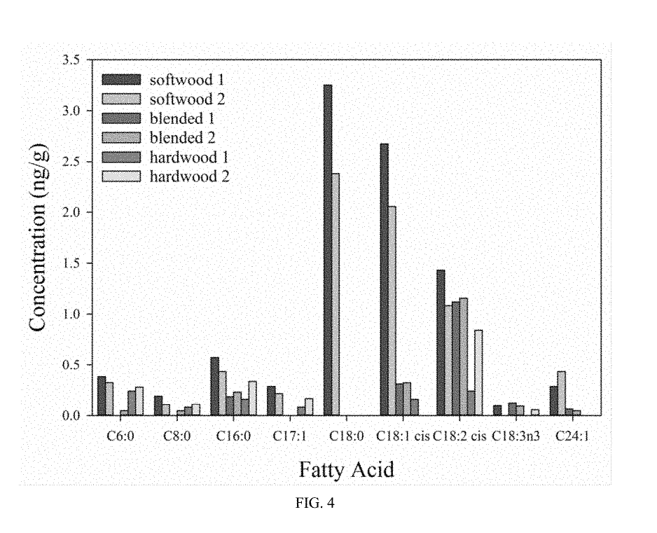

The oxidation of unsaturated fatty acids gives rise to aldehyde/ketone emissions from pellets. It has been postulated that carbon monoxide is formed due to autoxidative degradation of fats and fatty acids. Therefore, the concentration of fatty acids was measured from softwood, hardwood, and blended wood pellets. FIG. 4 shows the concentrations of various fatty acids in wood pellets. The average fatty acid concentrations were between 0.02 and 2.8 ng/g. These concentrations cannot explain the high concentration of CO off-gassing from wood pellets. At best, the fatty acids in softwood could account for approximately 8% of the CO, for 2% of the CO from blended pellets and 1% of the CO from hardwood pellets.

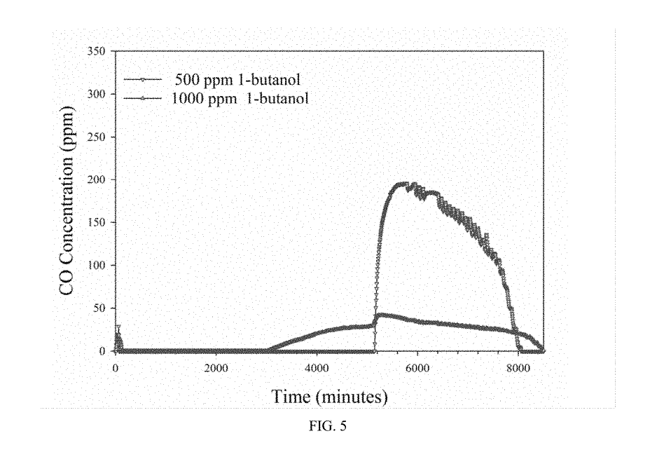

To further understand the oxidation process, the blended pellets were allowed to age in a small drum for 20 days and then the VOCs were sampled and analyzed by GC/MS. FIG. 5 presents the resulting chromatogram. Chromatograms of the headspace gas collected from 30 to 40 days of being in the drum showed similar results. In this case, octadecanoic and hexadecanoic acid peaks were observed with large peaks. A number of longer chain aldehydes particularly decanal and nonanal were observed similar to the results in earlier studies. In a previous study, only nonanal were detected inside two domestic houses adjacent to the closed pellet store, while decanal was not detected. In this VOCs study, formaldehyde, acetaldehyde, propionaldehyde, buturaldehyde, valeraldehyde, and hexanal were identified in a small drum containing wood pellets. However, the predominant peaks for both types of pellets were acetaldehyde, formaldehyde, and hexanal. These carbonyls are assumed to arise from the autoxidation of the fatty acids. Therefore, the aldehydes concentrations were measured and are presented in Table 1. However, the off-gassed CO concentration (1000 ppm) in the drum experiments is much higher than the aldehyde concentrations again suggesting that they cannot represent the source of the bulk of the observed CO.

TABLE 1
Concentration of Short Chain Aldehydes from Two Different Types of Wood Pellets

| | Conc. (ppb) | | | | | |
|---|---|---|---|---|---|---|
| Sample | Formaldehyde | Acetaldehyde | Propionaldehyde | Buturaldehyde | Valeraldehyde | Hexanal |

Soft wood pellets

| | | | | | | |
|---|---|---|---|---|---|---|
| Day 3 | 108 ± 12 | 575 ± 22 | 56 ± 2 | 71 ± 2 | 209 ± 2 | 631 ± 22 |
| Day 6 | 121 ± 10 | 1310 ± 28 | 60 ± 2 | 99 ± 5 | 678 ± 15 | 942 ± 31 |
| Day 9 | 135 ± 12 | 1744 ± 37 | 73 ± 4 | 106 ± 4 | 821 ± 35 | 1052 ± 45 |
| Day 12 | 151 ± 11 | 3614 ± 42 | 153 ± 7 | 158 ± 6 | 993 ± 52 | 1312 ± 41 |

Blended wood pellets

| | | | | | | |
|---|---|---|---|---|---|---|
| Day 3 | 614 ± 15 | 1127 ± 25 | 102 ± 8 | 42 ± 2 | 570 ± 12 | 832 ± 12 |
| Day 6 | 884 ± 18 | 1527 ± 33 | 124 ± 7 | 53 ± 1 | 718 ± 23 | 1131 ± 42 |
| Day 9 | 1277 ± 22 | 1695 ± 56 | 148 ± 8 | 79 ± 5 | 1068 ± 44 | 1368 ± 36 |
| Day 12 | 1757 ± 45 | 1813 ± 72 | 200 ± 6 | 112 ± 8 | 1224 ± 37 | 1422 ± 62 |

Nature of the Oxidant(s)

A number of studies have been performed to further understand the processes that lead to the formation of CO from the stored pellets. Since oxygen is the only oxidant present in the drums, it was assumed to be the species that lead to the off-gassing process. Thus, to confirm that oxygen was required to produce CO, a drum experiment was performed in which the container was filed with nitrogen. It is clear that oxygen is necessary to produce to measured CO. It appears there were minor leaks at times leading to some oxygen getting into these drums.

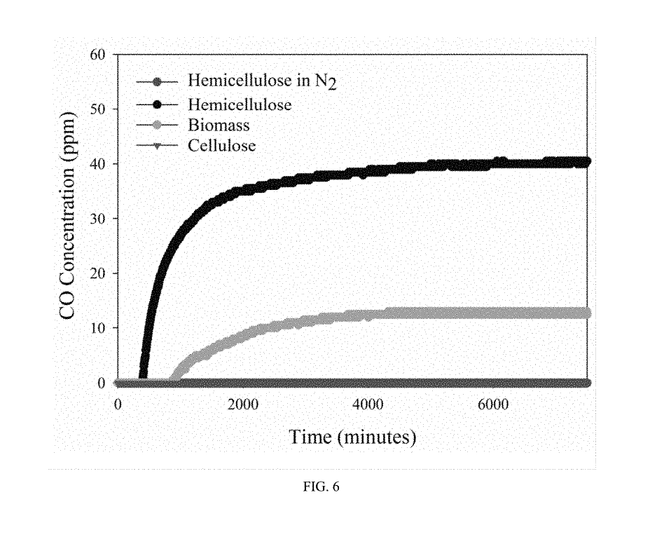

To understand which constituents of the pellets oxidized by the oxygen to produce CO, experiments with cellulose (2.0 g), hemicellulose (2.0 g) and biomass (8493 Monterey pine biomass) in a 1L container was conducted. These experiments were set up in normal air and nitrogen environment at room temperature. It was found that 2.0 g hemicellulose (Xylan) and 2.0 g of biomass (Glucan 43.7%; xylan 5.94%, arabinan 1.09%, galactan 1.89%, mannan 10.31% structural sugars 62.8% and lignin 28.2%) gives about 40 ppm and 15 ppm of CO, respectively, whereas hemicellulose produced no CO in nitrogen, as shown in FIG. 6. In addition, cellulose produces no CO in oxygen. These results clearly indicate that both hemicellulose and oxygen has an important role to produce CO off-gassing in room temperature.

It was hypothesized that the oxidation of hemicellulose is the primary source of the CO since the mass of CO is much greater than that of the aldehydes arising from the fatty acid oxidation. Moreover, hemicellulose will not be oxidized by molecular oxygen at room temperatures. Hydroxyl radical is known as the most reactive member of the oxygen radical family. Thus, if this mechanism is correct, a significant impact of hydroxyl radical scavengers such as short chain alcohols should be observable. Hydroxyl reacts to abstract the alcoholic H from the alcohol resulting in the much weaker oxidizer alkoxy radical.

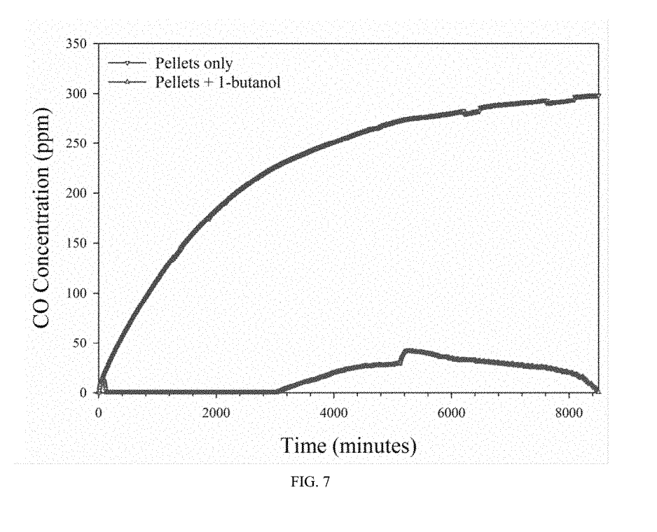

Thus, another small drum experiment was performed in which equal weights of bulk blended pellets were placed into two drums. To the second drum, 100 mL of 1-butanol was added to suppress the OH radicals. FIG. 7 shows that the presence of the butanol substantially suppressed the formation of CO suggesting both a role for hydroxyl radical and supporting the hypothesis that OH oxidation of the hemicellulose is the primary source of the evolved CO. To confirm the influence of hydroxyl radical on CO production, another experiment with different hydroxyl scavenger concentration (500 and 1000 ppm) was performed, as shown in FIG. 5. It can be seen the production of CO by 2 kg of pellets was delayed and reduced depending on the concentration of the radical scavenger.

Reaction Pathway Experiments

Therefore, the next question was what process forms the hydroxyl radicals in sufficient quantity to produce the observed quantities of CO. It was suggested that the autoxidation of unsaturated fatty acids and monoterpenes could be the source of the hydroxyl radicals. Indeed, this process leads to spoilage of foods that contain these substances. Of particular interest are oleic, linoleic, and linolenic acids. The rates of autoxidation depend on the degree of unsaturation with linolenic acid oxidizing 10 times faster than linoleic acid that is 10 times faster than oleic acid. Thus, linolenic acid will be effective at starting the autoxidation process. Although the fatty acids do not produce all of the observed CO, they initiate the reaction sequence that leads to the decomposition of the hemicellulose and formation of the observed CO.

Suppression of CO Formation Experiments

It was hypothesized that CO formation involves multiple processes including autoxidation of wood components like linoleic and linolenic acids as well as the terpenes that would exist in softwood. If the CO formation is due to the production of hydroxyl radicals by autoxidation, then it should be possible to reduce/limit the amount of off-gasing by destroying the reactive compounds that can autoxidize. Since these compounds have reactive double bonds, they will readily react with ozone across the double bond, form Criegee intermediates that will then decompose into lower reactivity species while forming hydroxyl radical. Thus, ozonolysis of the pellets should passivate them with respect to CO emissions or at least reduce the emissions substantially.

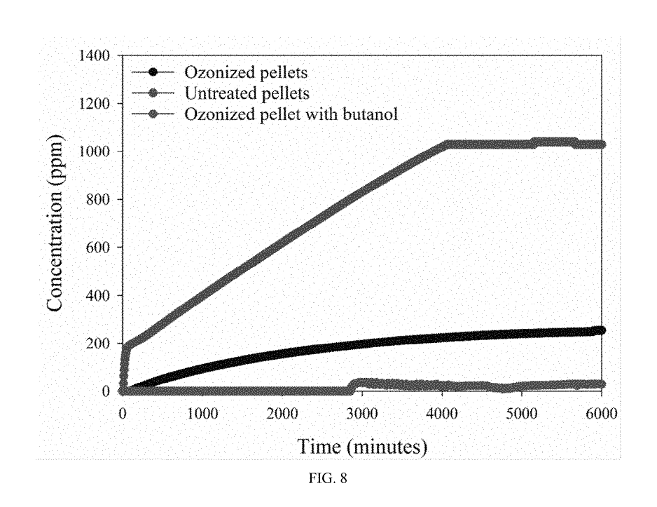

Accordingly, the pellets were exposed to high ozone concentrations (>10 ppm and beyond the ability to measure) in order to passivate the surface of the pellets. FIG. 8 compares the CO emanation from ozonized and unreacted pellets. Ozonation of the pellets reduced the maximum CO concentration by about a factor of 5, although some CO emissions were still observed. After ozone exposure on pellets, the evolved gas was collected and analyzed by GC-MS. This gas contains mostly hexanal, nonanal, and decanal indicating that oxidation of oleic, linoleic, and linolenic acids from the wood pellets. It may be that the delayed formation of CO occurs because of diffusion of the reactive compounds from the interior of the pellet where ozone could not react with them. As shown in FIG. 8, it was confirmed that hydroxyl radicals were involved since the additional of butanol again reduced the CO emissions to almost zero.

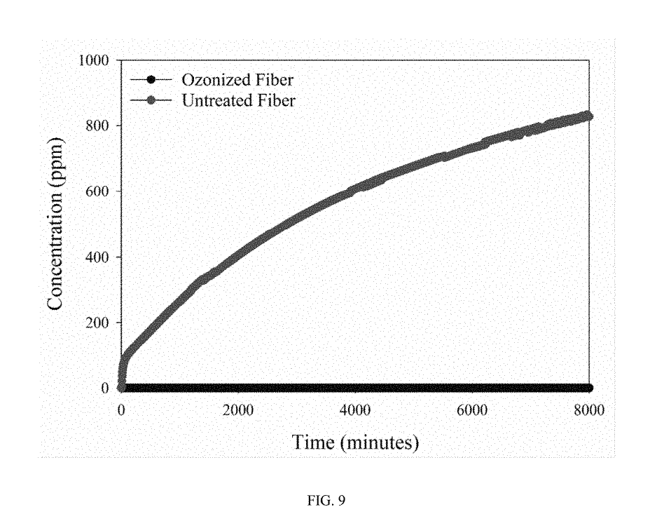

This result suggests that it is necessary to ensure that all of the fiber going into the pellet is exposed to ozone so all of the available reactive species are decomposed. Fresh fiber was obtained from the hopper of a pellet mill before it reached the auger that would have taken it to the press. Some of the fiber was exposed to ozone overnight. A comparison study was then conducted between the ozonized and as-received fiber. The results are shown in FIG. 9. It can be observed that there is no CO produced from the ozone passivated fiber, strongly supporting the hypothesized pathway for CO production.

Thus, a two-stage mechanism is proposed for the formation of CO by stored wood pellets. The process is initiated by the autoxidation of the unsaturated compounds in the wood leading to the formation of hydroxyl radicals. Both hardwood and softwood contain unsaturated fatty acids. Softwoods also contain monoterpenes that can also autoxidize and may explain the higher CO observed to be emitted by softwood pellets relative to hardwood pellets. Hydroxyl radicals can oxidize the hemicellulose leading to the bulk of the observed CO. This mechanism is consistent with the field measurements made in active pellet storage bins and in the various laboratory experiments. However, it is unlikely to provide the extremely high CO concentrations that resulted in the fatalities associated with CO emissions from pellets. In those cases, there were indications of increased temperatures associated with these events and thus, it may be that there was sufficient moisture in these locations (several pellet bins and the holds of ships) to permit biological activity leading to near spontaneous combustion conditions. Such a process would produce sufficiently large amounts of CO to lead to lethal concentrations.

Ozone Concentration/Time Product (Exposure)

To further test the suppression of CO emission by exposing the wood fiber to ozone, a series of experiments were performed using a small materials auger into which ozone could be injected. In these experiments the ozone concentrations and the duration of exposure were varied and a linear relationship was obtained between the extent of CO reduction and the exposure (concentration times contact time) such that exposure to at least 56,000 ppm-minutes of ozone exposure reduced to CO emissions to essentially zero.

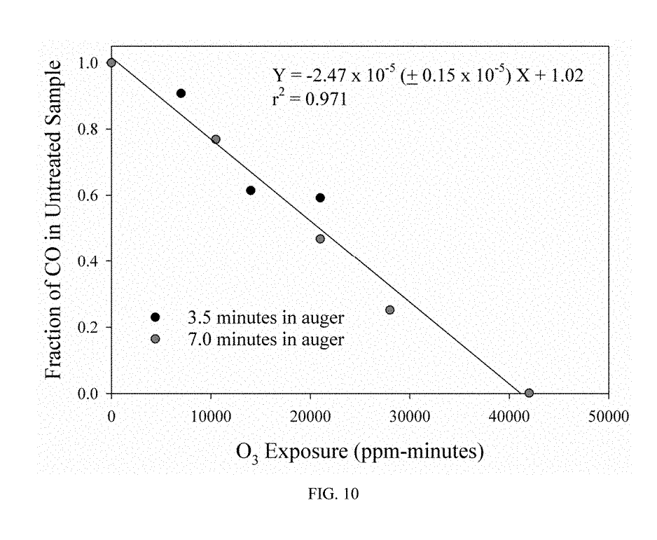

Referring to FIG. 10, in one embodiment, is a graph of the fractional reduction in CO as a function of the ozone concentration-time product (exposure) for two different auger speeds. In a first set of experiments, the fiber is in an auger for 3.5 minutes and exposed to ozone for the indicated exposure (black dots in FIG. 10), while in a second set of experiments the fiber is in the auger for 7 minutes and exposed to ozone for the indicated exposure (gray dots in FIG. 10). As shown by FIG. 10, the treatment is highly consistent and reproducible, as there is significant agreement between the two independent sets of experiments.

Materials And Methods

Fatty acids in wood pellets were extracted in a Soxhlet apparatus with a mixture of petroleum ether (bp 40-60° C.) and acetone (90 to10 v/v) as the solvent for 6 h and analyzed by GC-FID. The analytical method for the determination of fatty acid was compared with SRM 1947 (NIST) where the SRM recovery was 70-121%.

Thermogravimetric analysis of wood, cellulose and hemicellulose was carried out in TGA (Pyris 1, Perkin Elmer, USA). To mitigate the difference of heat and mass transfer, the sample weight was kept at ˜15 mg. Samples were heated to 800° C. at a constant heating of 10° C./min and maintained at this temperature for 3 min. Purified nitrogen (99.9995%) at a flow rate of 120 mL/min was used as the carrier gas to provide an inert atmosphere and to remove the gaseous and condensable products, thus minimizing any secondary vapor-phase interactions. The gases released in the TGA was collected immediately through the outlet tubing of TGA connected to a 1.0 L Tedlar® gas sampling bag. The TGA gas samples were screened with GC/MS (Thermo Electron TRACE GC with DSQ quadrupole MS).

For off-gassing studies of stored wood pellets, the pellets were placed in 20-gallon steel drums (20 in. in height and 16 in. in diameter). Two quick connects were inserted through each lid. The drums were sealed with a metal ring with a gasket to maintain an airtight fit. In these experiments, a Lascar CO monitor (model EL-USB-CO) was placed into each drum along with a Lascar temperature and relative humidity monitor (model EL-USB-2+). The accuracy of the sensors was verified by calibrating with calibration gas mixtures and a Thermo 146i gas calibrator coupled to a Thermo 110 zero air supply. Blended (˜40% softwood and ˜60% hardwood) and soft wood pellets were obtained from a local manufacturer. In general, the pellet samples were ˜6 mm in diameter and 6-25 mm in length with a bulk density of ˜18 Kg/m³ (40 lb s/ft³).

VOC samples were collected in the laboratory studies using a 10 mL gas-tight syringe connected with plastic tubing to a quick release fitting in the top of the drum. A headspace sample was collected by pulling the syringe. Samples were analyzed by injecting 3 μL of sample into the GC/MS. To sample for small chain aldehydes, a small pocket pump (SKC Inc.) was used to draw the air from the drum through a solid adsorbent tube (10% 2-(hydroxymethyl) piperdine on XAD-2, 120 mg/60). The sampling duration was 10 min with a flow rate of 100 mL/min. After sampling, the aldehydes were desorbed with 1.0 mL toluene and 60 min ultrasonic agitation. The short chain aldehydes samples were analyzed by the GC/MS. The analytical precision for replicate analyses of samples and standards were within ±10%. Five point calibrations curves were used to calculate the concentrations of the short chain aldehydes samples.

To study the effect of nitrogen, n-butanol, and ozone on pellets for the CO off-gassing, several rounds of drum experiments were performed with blended wood pellets that was considered as freshly produced according to manufacturer. The CO off-gassing was monitored as described above.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method for treating wood byproducts, the method comprising the steps of:
providing a first quantity of wood byproducts in a first location; and
exposing the first quantity of wood byproducts to ozone at a first concentration for a first time period, wherein the first concentration is configured to decrease the release of carbon monoxide from the first quantity of wood byproducts.

2. The method of claim 1, wherein said first concentration of said ozone for said first time period is at least approximately 60,000 ppm-minutes.

3. The method of claim 1, wherein the first concentration is configured to decrease the release of carbon monoxide from the first quantity of wood byproducts by at least approximately 90%.

4. The method of claim 1, wherein said wood byproducts are sawdust, wood chips, or wood pellets.

5. The method of claim 1, wherein said first location is a wood pellet mill.

6. A method for treating wood byproducts, the method comprising the steps of:
providing a first quantity of wood byproducts in a first location; and
exposing the first quantity of wood byproducts to ozone at a first concentration for a first time period, wherein said first concentration of said ozone for said first time period is at least approximately 60,000 ppm-minutes, and further wherein the first concentration is configured to decrease the release of carbon monoxide from the first quantity of wood byproducts by at least approximately 90%.

7. The method of claim 6, wherein said wood byproducts are sawdust, wood chips, or wood pellets.

8. The method of claim 6, wherein said first location is a wood pellet mill.
